(19) United States
(12) Patent Application Publication
(10) Pub. No.: US 2004/0172524 A1
(43) Pub. Date: Sep. 2, 2004

(54) Method, apparatus and compiler for predicting indirect branch target addresses

(76) Inventor: Jan Hoogerbrugge, Eindhoven (NL)

Correspondence Address: PHILIPS ELECTRONICS NORTH AMERICA CORPORATION, INTELLECTUAL PROPERTY & STANDARDS, 1109 MCKAY DRIVE, M/S-41SJ, SAN JOSE, CA, 95131, US

(21) Appl. No.: 10/482,014

(22) PCT Filed: Jun. 20, 2002
(86) PCT No.: PCT/IB02/02473

(30) Foreign Application Priority Data
Jun. 29, 2001 (EP) 01202499.8

(51) Int. Cl. G06F 15/00

(52) U.S. Cl. 712/239; 712/238

(57) ABSTRACT

The present invention relates to a method, processor and compiler for predicting a branch target of a program. A hint operation is provided in the program to hint the branch prediction about upcoming indirect branches. A table of branch targets of indirect branches can be used to improve prediction accuracy of indirect branches. The branch target is determined on the basis of a key information derived from the hint operation.

The present invention relates to a method, processor and compiler for predicting a branch target in a dynamic branch prediction.

As the issue rate und pipeline depth of high performance superscalar processors increase, the amount of speculative work issued also increases. Because speculative work must be thrown away in the event of a branch miss prediction, deeply pipelined processors must employ accurate branch predictors to effectively exploit their performance potential.

A program's branches can be categorized as conditional or unconditional and direct or indirect branches. A conditional branch conditionally redirects the instruction stream to a target whereas an unconditional branch always redirects the instruction stream to a target. A direct branch has a statically specified target which points to a single location in the program whereas an indirect branch has a dynamically specified target which may point to any number of locations in the program. Indirect branches can be categorized into four types resulting from modern imperative programming languages. These four types are function returns, table jumps resulting from switches, virtual function calls, and function calls via function pointers.

Dynamic branch prediction is commonly used to provide a steady stream of instructions to an instruction pipeline in the presence of branches. To achieve this, a fetch stage in the processor has to detect branches, predict branch directions (taken or not taken), and provide branch targets. A branch target buffer (BTB) is commonly used to provide branch targets. Whenever a branch is resolved, i.e. its direction and branch targets are known, its branch target is put in the BTB, which is essentially a cache of branch targets indexed by an instruction address. The BTB is accessed in the fetch stage of the pipeline with the same address that is used for accessing the instruction cache. If the BTB hits, the instruction fetched from the instruction cache must be a branch and the branch target returned by the BTB is predicted to be the target of the branch. This prediction will be correct for direct branches, i.e. branches with a target specified by an immediate operant, where the target address is static.

However, the target prediction made by the BTB will very often be incorrect for indirect branches, i.e. branches with a target specified by a register, where the branch target address is dynamic. Although indirect branches are less frequently used than direct branches, they are important because they are much harder to predict. Simulation results indicate that better prediction of indirect branches improves accuracy significantly.

Target predictors for indirect branches have been proposed by Po-Yung Chang et al in “Target Prediction for Indirect Jumps”, Proceedings of the 24th International Symposium on Computer Architecture, Denver, June 1997, and by Karel Driesen et al in “Accurate Indirect Branch Prediction”, Proceedings of the 25th Annual International Symposium on Computer Architecture, Barcelona, Spain, June 1998. These predictors provide a target based on the address of the branch and the execution path leading to the branch whereas a BTB provides a target only based on the address of the branch. The idea behind these predictors is to use correlation that exists between the path leading to the indirect branch and its target. A consequence of this technique is many targets are stored per indirect branch.

Furthermore, compiler synthesized dynamic branch prediction (CS-DBP) procedures are known from the U.S. Pat. No. 5,857,104, where the compiler communicates dynamically computed values to the branch predictor that allows the branch predictor to improve predictions. However, the known CS-DBP procedures provide a probabilistic approach where only branch directions or values correlated to branch directions are predicted.

It is therefore an object of the present invention to provide a method, processor and compiler for branch prediction, by means of which the prediction accuracy of indirect branches can be improved.

This object is achieved by a prediction method as defined in claim 1, by a processor as defined in claim 11, and by a compiler as defined in claim 14.

According to the invention, an operation to hint the branch prediction about upcoming indirect branches is provided, wherein either a table of branch targets of indirect branches or a compiler determination can be used to improve prediction accuracy of indirect branches. In particular, a hint is given to the hardware about an upcoming indirect branch, wherein a key information relating to the target of the branch is derived.

The application of this technique improves the target prediction accuracy of indirect branches significantly, except for the first execution of the branch in a certain direction. Hence, nearly all target predictions lead to a correct target provided a sufficiently large branch target buffer or table is provided.

The compiler is useful for prediction of indirect branches resulting from function pointers. In this case, a branch target determined by the compiler is available in time.

The key information may be derived from a switch value of a switch statement from which the branch results. Furthermore, the key information may be derived from an address of a virtual function table of a virtual function call from which the branch results. Due to the fact that nearly all indirect branches are resulting from function returns and switch statements, an efficient and accurate branch prediction can be provided. If the load latency of the processor (e.g. a VLIW processor) is selected to be equal to the number of front-end pipeline stages, the hint operation can be scheduled in parallel with the load operation. Preferably, the hint operation may be provided at a predetermined location of the program, the predetermined location being selected such that the hint operation is an execution phase of an instruction execution cycle when the corresponding branch instruction is in a fetch phase of the instruction execution cycle. Thus, the hint operation will reach the execution stage of the processor when the indirect branch is fetched. Thereby, a direct feed-back to the branch prediction in the fetch stage can be given.

The key information may be hashed with the address of the branch instruction or the instruction incorporating the hint operation, to obtain an index used to access the branch target table. The branch target table may be an indirect branch target buffer comprising branch targets for indirect branches. The branch targets stored in the branch target table may be most recently used entries of jump tables and/or virtual function tables. Thereby, a time advantage can be achieved in case of long access times to the data cache.

The access means of the processor may comprise hashing means for hashing the key information with an address of an execute stage or a fetch stage of the processor. Thereby, an index used to access the indirect branch target buffer can be generated in a simple and fast manner.

In the following, a preferred embodiment of the present invention will be described in greater detail with reference to the accompanying drawing figures in which:

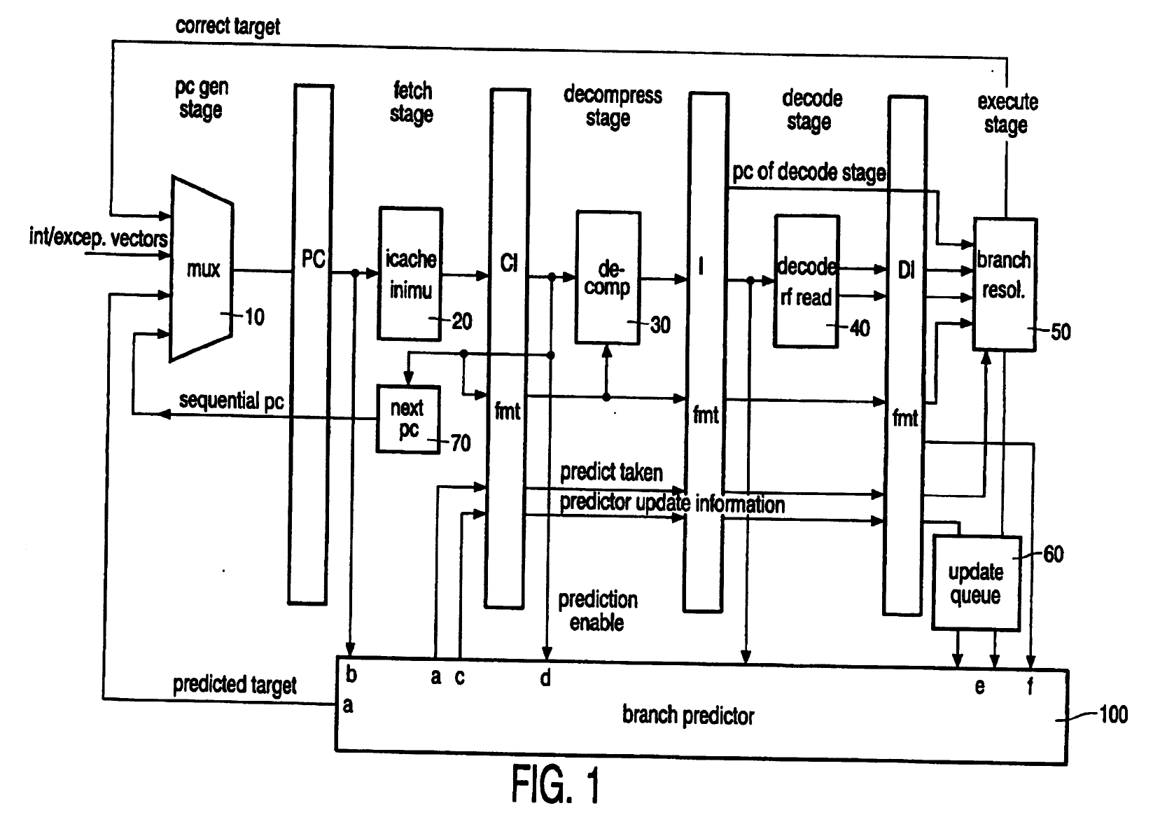

FIG. 1 shows a schematic block diagram of a processor according to the preferred embodiment;

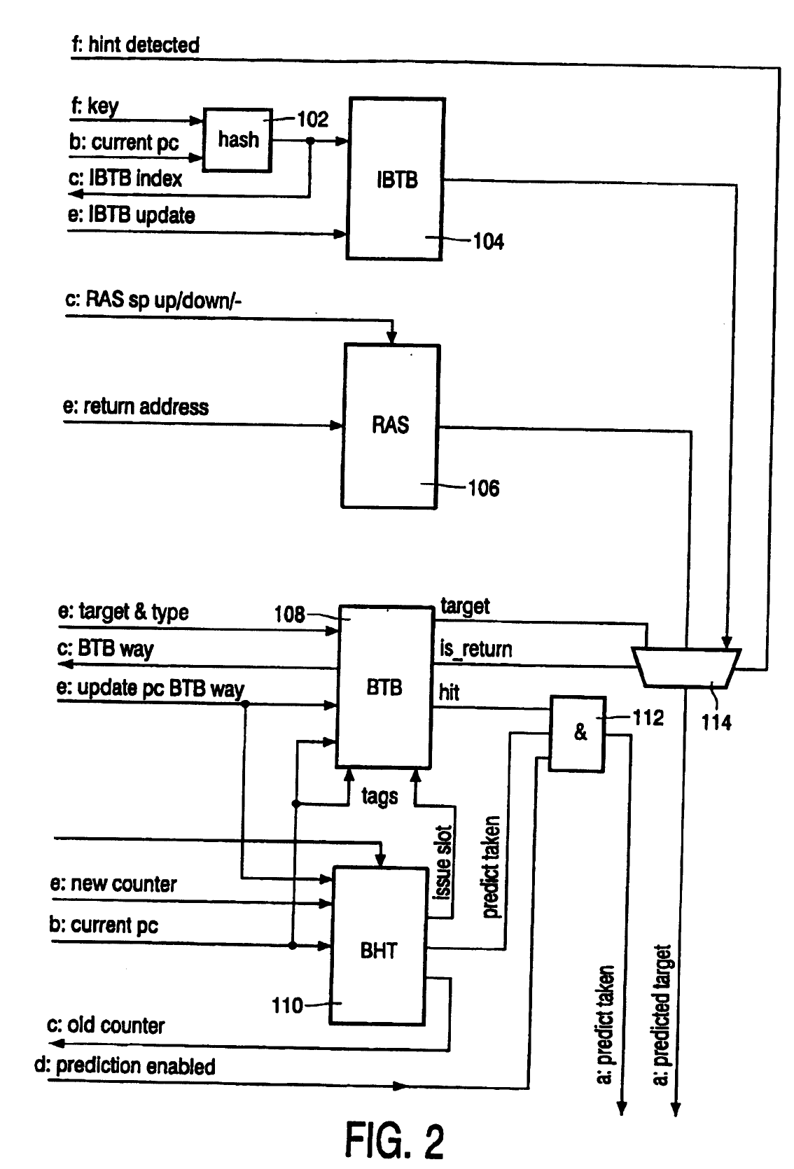

FIG. 2 shows a schematic block diagram of a branch predictor provided in the processor according to the preferred embodiment;

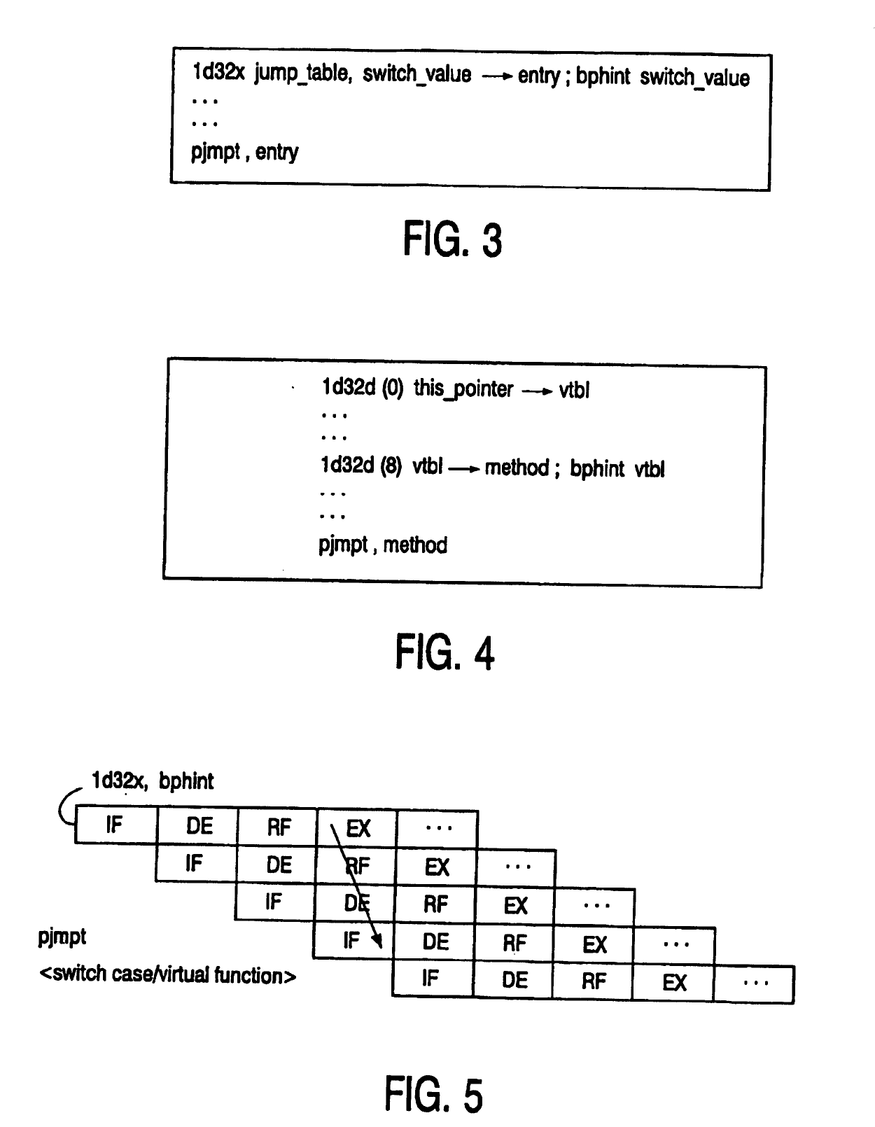

FIG. 3 shows an implementation of a switch statement comprising a hint operation;

FIG. 4 shows an implementation of a virtual function call comprising a hint operation; and

FIG. 5 shows a pipelined execution of a load operation comprising the hint operation, and an indirect branch operation.

The preferred embodiment will now be described on the basis of an architecture of a VLIW (Very Long Instruction Word) processor as indicated in FIG. 1.

As can be gathered from FIG. 1, a branch resolution function 50 is provided in the execute stage of the processor and is arranged to supply the correct branch target to a multiplexor 10 of a program counter generation stage. The multiplexor 10 is supplied with the next sequential program counter generated by a next program counter functionality 70 and with a predicted branch target generated by a branch predictor 100. Furthermore, interrupt vectors or other exceptional vectors can be applied to the multiplexor 10 which then outputs a selected program counter to be supplied to an instruction cache memory 20 of a fetch stage. The current program counter is further supplied to the branch predictor 100. Based on the current program counter, the instruction cache 20 outputs a compressed instruction which is supplied to a decompressor 30 of a decompress stage so as to generate the current instruction word. It is noted that the decompress stage not necessarily has to be provided in VLIW processors, only in case compressed instructions are used. The instruction word is then supplied to an instruction decoder 40 of a decode stage, where the VLIW instruction is decoded and supplied to the branch resolving unit 50. Furthermore, the execute stage comprises an update queue unit 60 for updating branch target buffers provided in the branch predictor 100. This update is performed on the basis of a predictor update information output from the branch predictor 100. Furthermore, the branch predictor 100 outputs a predict taken information supplied to the branch resolving unit 50 of the execute stage.

According to the preferred embodiment, a hint operation is added to or incorporated in an instruction to pass a key to the processor hardware about an upcoming indirect branch. Then, when the indirect branch is fetched and its target has to be predicted, the hint operation is or becomes available at the execute stage, such that the key information can be supplied to the branch predictor 100. As indicated in FIG. 1, a portion of the decoded instruction is supplied to the branch predictor 100, as indicated by an arrow pointing from the decoded instruction to the input f of the branch predictor 100. Thus, the branch predictor 100 may notice that a hint to an indirect branch is given and may accept the supplied key information in order to access the corresponding branch target buffer.

FIG. 2 shows a schematic block diagram of the branch predictor 100 indicated in FIG. 1. According to FIG. 2, the branch predictor 100 comprises a branch target buffer (BTB) 108 which is a cache where instruction addresses are associated with branch targets. If an instruction address hits in the BTB 108, it is known that the address relates to a branch instruction and a prediction will be generated and output via a target selector 114.

Furthermore, a branch history table (110) is provided, which predicts the branch direction. The BHT 110 predicts the direction of conditional branches, i.e. whether a branch is taken or not. This may typically be implemented by a table of two bit saturating counters indexed by the lower part of the program counter. Such a counter is incremented when a resolved branch is taken and is decremented when it is not taken. A branch is predicted as taken if the most significant bit of the corresponding two bit counter is set. The two bit counter may comprise weak and strong states to introduce some form of hysteresis in the branch predictor 100. Whenever a branch that is in one direction is mispredicted, a second chance can be given before changing the prediction. This is achieved by moving from a strong to a weak state, but maintaining the same prediction. Whenever the branch is mispredicted again, the prediction is changed. In case of a correct prediction, the state is moved back to the strong state. Due to the fact that the BHT 110 is a tag-less table, conflicts of mapping multiple branches onto the same counter are not detected. When the prediction is enabled by the decompress stage of FIG. 1, an AND-gate 112 opens to output the predict taken information.

Additionally, the prediction of function returns can be improved by maintaining a return address stack (RAS) 106. Function call branches push the return address on the RAS 106 and function return branches pop values of the RAS 106. To determine the branche type, which is necessary to detect function returns in the fetch stage, the BTB 108 usually also associates type information with instruction addresses. Alternatively, a type information can be precoded in the instruction cache 20.

In the preferred embodiment, a hint detected information is applied to the input f of the branch predictor 100 if a hint operation is detected in the decode stage. The hint detected information is supplied to the target selector 114 of the branch predictor 100 so as to select the output of an additional indirect branch target buffer (IBTB) 104 provided in the branch predictor 100. Furthermore, a key information derived from the hint operation is supplied to the input f of the branch predictor 100, from where it is supplied to an internal hash unit 102 in which the key information is hashed with the current program counter supplied from the fetch stage via input d. Thus, an upcoming indirect branch is hinted with a key that relates to the target of the branch. In case of an instruction relating to a switch statement, the key may be the switch value of the switch statement. Furthermore, in case of an instruction relating to a virtual function call, the key may be the address of the virtual function table of the virtual function call. The key information or key is then hashed in the hash unit 102 with the address (program counter) of the instruction comprising the hint operation to obtain an index in a tag-less table of the branch targets of the IBTB 104.

The IBTB 104 may be updated by the update queue unit 60 of the execute stage based on an output of the branch resolving unit 50 and the predictor update information which comprises the IBTB index output from the branch predictor 100.

FIGS. 3 and 4 show how a switch statement and virtual function call are implemented. In both cases an operation called “bphint” is used to pass a key to the hardware about an upcoming indirect branch. Regarding FIG. 3, the general expression “ld32x a, i→v” means “v=a[i]”, and, regarding FIG. 4, the general expression “ld32d(0) a→v” means “v=a[0]”. When the indirect branch “pjmpt” is fetched and its target has to be predicted by the branch predictor 100, the bthint operation is in the execute stage as shown in FIG. 5, where the concurrent content of the successive stages of the VLIW processor are shown in vertical columns at different points in time.

The branch predictor 100 is noticed by the signal at its input f that an indirect branch has been fetched, and the derived key information is hashed to generate an index for accessing the IBTB 104 so as to generate and output a branch target via the target selector 114 and the output a of the branch predictor 100. The IBTB index is output via the output c and is passed through the pipeline from the fetch stage to the execute stage where it is used to update the IBTB 104.

In FIGS. 3 and 4, each line corresponds to one VLIW instruction, wherein the switch statement in FIG. 3 consists of a table look up followed by an indirect branch, and wherein the virtual function call implementation of FIG. 4 consists of a load of the virtual function table pointer followed by a load of the method pointer from this table and an indirect branch to the method.

FIG. 5 relates to the virtual function call of FIG. 4, wherein the arrow shows how information is passed from the hint operation in the execute stage to the fetch stage, to thereby provide an improved branch prediction for indirect branches. In FIG. 5, each line indicates successive processing stages of an instruction indicated at the left side of FIG. 5, wherein the shift of the lines indicates the pipeline processing of the instructions. When the load instruction comprising the bphint operation is located in the first execute stage, then the pjmpt branch instruction is located in the fetch stage.

It is noted that the described technique could also be useful for prediction of indirect branches resulting from function pointers. In this case, a compiler has to detect a value to be used as the key based on which the branch target is determined or computed to be available in time. In particular, the compiler derives (e.g. extracts or decodes) the key information from the detected hint operation. The derived key information may be directly used by the compiler to determine the branch target. As an alternative, the compiler may access the IBTB 104 to obtain the branch taget.

If the load latency is equal to the number of front-end pipeline stages of the VLIW processor, as indicated above, the hint operation can be scheduled in parallel with the load operation. The hint operation will reach the execute stage when the indirect branch is fetched. In case the load latency is longer than the front-end of the pipeline the hint operation can be scheduled later than the load operation. In case the load latency is shorter than the number of front-end stages, the indirect branch might have to be scheduled later in order to be able to use the key provided by the hint operation. This might increase the instruction count and thus decrease the usefulness of the hinting procedure.

As an alternative, the proposed technique may be implemented as a cache for entries of jump tables and virtual function tables. Then, most recently used entries of these tables are stored in the IBTB 104. Such a cache function may be useful if the access to the normal data cache is time consuming.

Thus, compared to the known CS-DBT techniques initially described, the present invention suggests predicting branch targets and providing a key to the branch predictor that is directly related to the branch targets. Thereby, a deterministic approach is achieved.

It is noted that any kind of hint operation can be provided for deriving any kind of key information suitable to provide an index or other kind of access to the indirect branch target buffer or other target table. Furthermore, any kind of hashing scheme may be used to generate the index information from the key information. Several variations of the tag-less indirect target cache can be implemented. They may differ in the ways that the key information and the instruction address information are hashed into the IBTB 104. Consequently, the present invention is not restricted to the preferred embodiment described above, and can be applied to any processor arrangement comprising a branch prediction function. The invention is intended to cover any modification within the scope of the attached claims.

1. A method of predicting a branch target of a program, said method comprising the steps of:
a) providing a branch target table (104) comprising a plurality of branch targets;
b) using a hint operation in said program for deriving a key information; and
c) selecting said branch target from said branch target table (104) based on said key information.

2. A method according to claim 1, wherein said key information is derived from a switch value of a switch statement from which the branch results.

3. A method according to claim 1 or 2, wherein said key information is derived from an address of a virtual function table of a virtual function call from which the branch results.

4. A method according to anyone of the preceding claimsclaim 1, wherein said hint operation is incorporated into a VLIW instruction.

5. A method according to anyone of the preceding claimsclaim 1, wherein said key information is hashed with the address of the branch instruction or the instruction incorporating said hint operation, to obtain an index used to access said branch target table (104).

6. A method according to anyone of the preceding claims, wherein said branch target table is an indirect branch target buffer (104) comprising branch targets for indirect branches.

7. A method according to anyone of the preceding claimsclaim 1, wherein said hint operation is provided at a predetermined location of said program, said predetermined location being selected such that the hint operation is in an execution phase of an instruction execution cycle when the corresponding branch instruction is in a fetch phase of the instruction execution cycle.

8. A method according to anyone of the preceding claimsclaim 1, wherein said prediction method is used to predict a branch target of an indirect branch resulting from a function pointer.

9. A method according to anyone of the preceding claimclaim 1, further comprising the step of storing in said branch target table most recently used entries of jump tables and/or virtual function tables.

10. A method according to anyone of the preceding claimsclaim 1, wherein said prediction method is a compiler synthesized dynamic branch prediction method.

11. A processor for predicting a branch target of a program, said processor comprising:
a) branch target buffer means (104) for storing a plurality of branch targets;
b) decoding means (4) for detecting a hint operation of said program and for deriving a key information from said hint operation;
c) access means (102) for accessing said branch target buffer means (104) using said key information to select said branch target.

12. A processor according to claim 11, wherein said branch target buffer means (104) is arranged to store indirect branch targets, and wherein a further branch target buffer means (108) is provided for storing direct branch targets.

13. A processor according to claim 11 or 12, wherein said access means comprises hashing means (102) for hashing said key information with an address of an execute stage or a fetch stage of said processor.

14. A compiler for predicting a branch target of a program, wherein said compiler is arranged to detect a hint operation of said program, to derive a key information from said hint operation, and to determine said branch target based on said key information.

15. A compiler according to claim 14, wherein said branch target results from an indirect branch of a function pointer.
